(19) United States
(12) Patent Application Publication
(10) Pub. No.: US 2025/0364771 A1
(43) Pub. Date: Nov. 27, 2025

(54) GAS LASER APPARATUS AND ELECTRONIC DEVICE MANUFACTURING METHOD

(71) Applicant: Gigaphoton Inc., Tochigi (JP)

(72) Inventors: Kazuki NAGAI, Oyama-shi (JP); Takeshi UEYAMA, Oyama-shi (JP)

(73) Assignee: Gigaphoton Inc., Tochigi (JP)

(21) Appl. No.: 19/294,242

(22) Filed: Aug. 7, 2025

Related U.S. Application Data
(63) Continuation of application No. PCT/JP2023/009158, filed on Mar. 9, 2023.

(51) Int. Cl. H01S 3/097; H01S 3/038; H01S 3/09; H01S 3/22

(52) U.S. Cl. CPC H01S 3/09702; H01S 3/0384; H01S 3/0906; H01S 3/22

(57) ABSTRACT

A gas laser apparatus according to an aspect of the present disclosure includes a laser chamber, a primary electrode, a preliminary ionization electrode, a power supplier, and a processor. The laser chamber is configured to encapsulate a laser gas containing a fluorine gas. The primary electrode is disposed in the laser chamber. The preliminary ionization electrode is disposed in the laser chamber. The power supplier is configured to supply power to the primary electrode and the preliminary ionization electrode. The processor is configured to control the power supplier to perform first discharge control that causes the preliminary ionization electrode and the primary electrode to perform discharge, and second discharge control that causes only the preliminary ionization electrode to perform discharge without causing the primary electrode to perform discharge.

### CROSS-REFERENCE TO RELATED APPLICATIONS

The present application is a continuation application of International Application No. PCT/JP2023/009158, filed on Mar. 9, 2023, the entire contents of which are hereby incorporated by reference.

### BACKGROUND

### 1. Technical Field

The present disclosure relates to a gas laser apparatus and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from KrF and ArF excimer laser apparatuses performing spontaneous laser oscillation has a wide spectral linewidth ranging from 350 to 400 pm. A projection lens made of a material that transmits ultraviolet light, such as the KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

PTL 1: JP-A-11-135858

### SUMMARY

A gas laser apparatus according to an aspect of the present disclosure includes a laser chamber, a primary electrode, a preliminary ionization electrode, a power supplier, and a processor. The laser chamber is configured to encapsulate a laser gas containing a fluorine gas. The primary electrode is disposed in the laser chamber. The preliminary ionization electrode is disposed in the laser chamber. The power supplier is configured to supply power to the primary electrode and the preliminary ionization electrode. The processor is configured to control the power supplier to perform first discharge control that causes the preliminary ionization electrode and the primary electrode to perform discharge, and second discharge control that causes only the preliminary ionization electrode to perform discharge without causing the primary electrode to perform discharge.

An electronic device manufacturing method according to another aspect of the present disclosure includes: generating laser light by using a gas laser apparatus; outputting the laser light to an exposure apparatus; and exposing a photosensitive substrate to the laser light in the exposure apparatus to manufacture electronic devices, the gas laser apparatus including a laser chamber configured to encapsulate a laser gas containing a fluorine gas, a primary electrode disposed in the laser chamber, a preliminary ionization electrode disposed in the laser chamber, a power supplier configured to supply power to the primary electrode and the preliminary ionization electrode, and a processor configured to control the power supplier to perform first discharge control that causes the preliminary ionization electrode and the primary electrode to perform discharge, and second discharge control that causes only the preliminary ionization electrode to perform discharge without causing the primary electrode to perform discharge.

### BRIEF DESCRIPTION OF THE DRAWINGS

Some embodiments of the present disclosure will be described below only by way of example with reference to the accompanying drawings.

FIG. 1 is a side view schematically showing the configuration of a gas laser apparatus according to Comparative Example.

FIG. 2 is a cross-sectional view schematically showing the configuration of the gas laser apparatus according to Comparative Example.

FIG. 3 is a circuit diagram schematically showing the configuration of a power supplier according to Comparative Example.

FIG. 4 is a flowchart showing the procedure of processes carried out by a processor according to a first embodiment.

FIG. 5 is a circuit diagram schematically showing the configuration of a power supplier according to a second embodiment.

FIG. 6 shows graphs showing a result of a simulation of various voltages applied to the power supplier according to the second embodiment.

FIG. 7 is a circuit diagram schematically showing the configuration of a power supplier according to a third embodiment.

FIG. 8 shows graphs showing a result of a simulation of various voltages applied to the power supplier according to the third embodiment.

FIG. 9 is a circuit diagram schematically showing the configuration of a power supplier according to a fourth embodiment.

FIG. 10 shows graphs showing a result of a simulation of various voltages applied to the power supplier according to the fourth embodiment.

FIG. 11 is a circuit diagram schematically showing the configuration of a power supplier according to a fifth embodiment.

FIG. 12 schematically shows an example of the configuration of an exposure apparatus.

### DETAILED DESCRIPTION

### Contents

1. Comparative Example
1.1 Gas laser apparatus
1.1.1 Configuration
1.1.2 Operation
1.2 Power supplier
1.2.1 Configuration
1.2.2 Operation
1.3 Problems
2. First Embodiment
2.1 Configuration
2.2 Operation
2.3 Advantages
3. Second Embodiment
3.1 Configuration
3.2 Operation
3.3 Advantages
4. Third Embodiment
4.1 Configuration
4.2 Operation
4.3 Advantages
5. Fourth Embodiment
5.1 Configuration
5.2 Operation
5.3 Advantages
6. Fifth Embodiment
6.1 Configuration
6.2 Operation
6.3 Advantages
7. Variations
8. Electronic device manufacturing method

Embodiments of the present disclosure will be described below in detail with reference to the drawings. The embodiments described below show some examples of the present disclosure and are not intended to limit the contents of the present disclosure. Furthermore, all configurations and operations described in the embodiments are not necessarily essential as configurations and operations in the present disclosure. Note that the same element has the same reference character, and no duplicate description of the same element will be made.

### 1. Comparative Example

Comparative Example of the present disclosure will first be described. Comparative Example of the present disclosure is an aspect that the applicant is aware of as known only by the applicant, and is not a publicly known example that the applicant is self-aware of.

### 1.1 Gas Laser Apparatus

### 1.1.1 Configuration

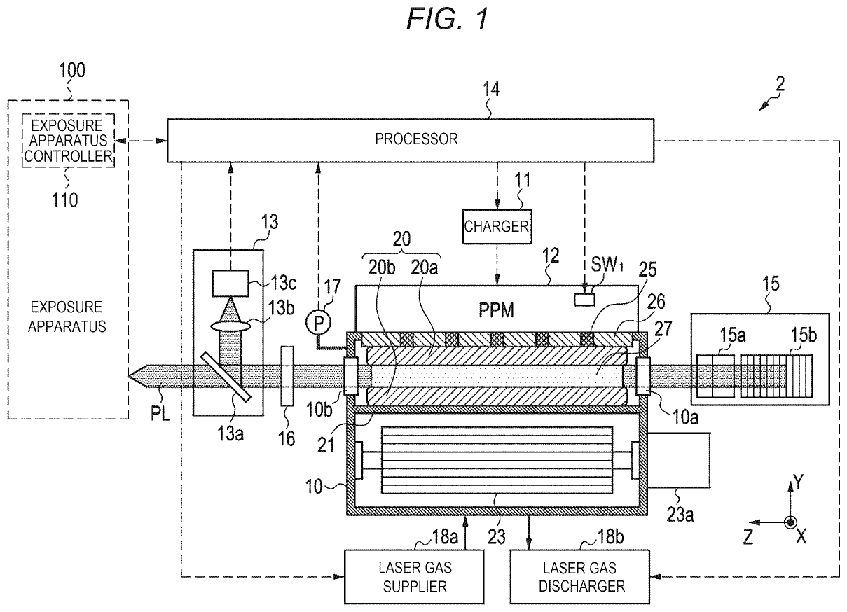

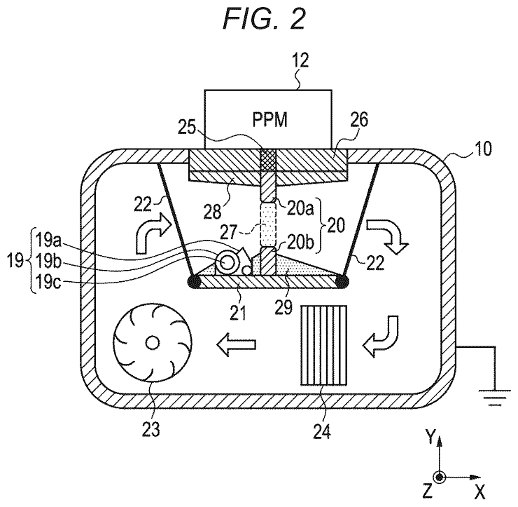

The configuration of a gas laser apparatus 2 according to Comparative Example will be described with reference to FIGS. 1 and 2. FIG. 1 schematically shows the configuration of the gas laser apparatus 2. FIG. 2 is a cross-sectional view of the gas laser apparatus 2 shown in FIG. 1 and viewed in a Z direction. The gas laser apparatus 2 is a discharge-excitation gas laser apparatus that excites a laser gas through discharge, and is, for example, an excimer laser apparatus.

It is assumed in FIG. 1 that a traveling direction of pulse laser light PL output from the gas laser apparatus 2 is the Z direction. It is further assumed that a discharge direction that will be described later is a Y direction. It is further assumed that a direction orthogonal to the Z and Y directions is an X direction. Note that the pulse laser light PL is an example of “laser light” according to the technology of the present disclosure.

In FIG. 1, the gas laser apparatus 2 includes a laser chamber 10, a charger 11, a pulse power module (PPM) 12, a pulse energy measuring unit 13, a processor 14, a pressure sensor 17, and a laser resonator. A line narrowing module 15 and an output coupler (OC) 16 constitute the laser resonator. Note that the charger 11 is an example of a “first power supply” according to the technology of the present disclosure. The PPM 12 is an example of a “power generation circuit” according to the technology of the present disclosure.

The laser chamber 10 is, for example, a metal container made of aluminum and having a surface plated with nickel. A primary electrode 20, a ground plate 21, wires 22, a fan 23, a heat exchanger 24, a preliminary ionization electrode 19, electrically insulating guides 28, and metal dampers 29 are provided in the laser chamber 10, as shown in FIGS. 1 and 2. The preliminary ionization electrode 19 includes a preliminary ionization outer electrode 19a, a dielectric pipe 19b, and a preliminary ionization inner electrode 19c.

A laser gas containing fluorine is encapsulated as a laser medium in the laser chamber 10. The laser gas includes, for example, argon, krypton, xenon, or any other element as a rare gas, neon, helium, or any other element as a buffer gas, and fluorine, chlorine, or any other element as a halogen gas.

The laser chamber 10 further has an opening. An electrically insulating plate 26, in which feedthroughs 25 are embedded, is attached to the laser chamber 10 via an O-ring that is not shown so as to close the opening. The PPM 12 is disposed on the electrically insulating plate 26. The laser chamber 10 is grounded.

The PPM 12 includes a charging capacitor C₀, which will be described later, and is connected to the primary electrode 20 via the feedthroughs 25. The PPM 12 includes a switch SW₁, which causes the primary electrode 20 to perform discharge. The charger 11 is connected to the charging capacitor C₀ of the PPM 12. The discharge that occurs at the primary electrode 20 is hereinafter referred to as primary discharge. Note that the switch SW₁ is an example of a “first switch” according to the technology of the present disclosure.

The primary electrode 20 is configured with a cathode electrode 20a and an anode electrode 20b. The cathode electrode 20a and the anode electrode 20b are so disposed that the discharge surfaces thereof face each other in the laser chamber 10. The space between the discharge surface of the cathode electrode 20a and the discharge surface of the anode electrode 20b is called a discharge space 27. The surface of the cathode electrode 20a that is opposite to the discharge surface thereof is supported by the electrically insulating plate 26, and connected to the feedthroughs 25. The surface of the anode electrode 20b that is opposite to the discharge surface thereof is supported by the ground plate 21.

The ground plate 21 is connected to the laser chamber 10 via the wires 22. The laser chamber 10 is grounded. The ground plate 21 is therefore grounded via the wires 22. Ends of the ground plate 21 in the Z direction are fixed to the laser chamber 10.

The fan 23 is a crossflow fan used to circulate the laser gas in the laser chamber 10, and is disposed on the side opposite to the discharge space 27 with the ground plate 21 disposed therebetween. A motor 23a, which rotationally drives the fan 23, is connected to the laser chamber 10.

The laser gas blown out from the fan 23 flows into the discharge space 27. A flowing direction of the laser gas flowing into the discharge space 27 is substantially parallel to the X direction. The laser gas flowing out of the discharge space 27 can be suctioned into the fan 23 via the heat exchanger 24. The heat exchanger 24 exchanges heat between a refrigerant having been supplied into the heat exchanger 24 and the laser gas.

The electrically insulating guides 28 are disposed at a surface of the electrically insulating plate 26 that is the surface on the discharge space 27 side, so as to sandwich the cathode electrode 20a. The electrically insulating guides 28 are shaped so as to guide the flow of the laser gas so that the laser gas from the fan 23 efficiently flows between the cathode electrode 20a and the anode electrode 20b. The electrically insulating guides 28 and the electrically insulating plate 26 are made, for example, of a ceramic material such as alumina (Al₂O₃), which has low reactivity with fluorine gas.

The metal dampers 29 are disposed at a surface of the ground plate 21 that is the surface on the discharge space 27 side, so as to sandwich the anode electrode 20b. The metal dampers 29 are made, for example, of porous nickel having low reactivity with fluorine gas.

A laser gas supplier 18a and a laser gas discharger 18b are connected to the laser chamber 10. The laser gas supplier 18a includes a valve and a flow rate control valve, and is connected to a gas cylinder containing the laser gas. The laser gas discharger 18b includes a valve and a discharge pump.

Windows 10a and 10b are provided at ends of the laser chamber 10 to cause light generated in the laser chamber 10 to exit out thereof. The laser chamber 10 is so disposed that the optical path of the optical resonator passes through the discharge space 27 and the windows 10a and 10b.

The line narrowing module 15 includes a prism 15a and a grating 15b. The prism 15a increases the beam width of the light having exited out of the laser chamber 10 via the window 10a, and transmits the light toward the grating 15b.

The grating 15b is disposed in the Littrow arrangement, which causes the angle of incidence of the light incident on the grating 15b to be equal to the angle of diffraction of the light diffracted by the grating 15b. The grating 15b is a wavelength selector that selectively extracts light having a specific wavelength and wavelengths in the vicinity thereof in accordance with the angle of diffraction. The light that returns from the grating 15b to the laser chamber 10 via the prism 15a has a narrowed spectral width.

The output coupler 16 transmits part of the light output from the laser chamber 10 via the window 10b and reflects the other part of the light back into the laser chamber 10. The surfaces of the output coupler 16 are each coated with a partially reflective film.

The light output from the laser chamber 10 travels back and forth between the line narrowing module 15 and the output coupler 16 and is amplified whenever passing through the discharge space 27. Part of the amplified light is output as the pulse laser light PL via the output coupler 16.

The pulse energy measuring unit 13 is disposed in the optical path of the pulse laser light PL output via the output coupler 16. The pulse energy measuring unit 13 includes a beam splitter 13a, a light collection optical system 13b, and a photosensor 13c.

The beam splitter 13a transmits the pulse laser light PL at high transmittance and reflects part of the pulse laser light PL toward the light collection optical system 13b. The light collection optical system 13b collects the light reflected off the beam splitter 13a at the light receiving surface of the photosensor 13c. The photosensor 13c measures the pulse energy of the light collected at the light receiving surface, and outputs the measured value to the processor 14.

The pressure sensor 17 detects the gas pressure in the laser chamber 10 and outputs the detected value to the processor 14. The processor 14 determines the gas pressure of the laser gas in the laser chamber 10 based on the detected value of the gas pressure and a charging voltage Vhv applied by the charger 11.

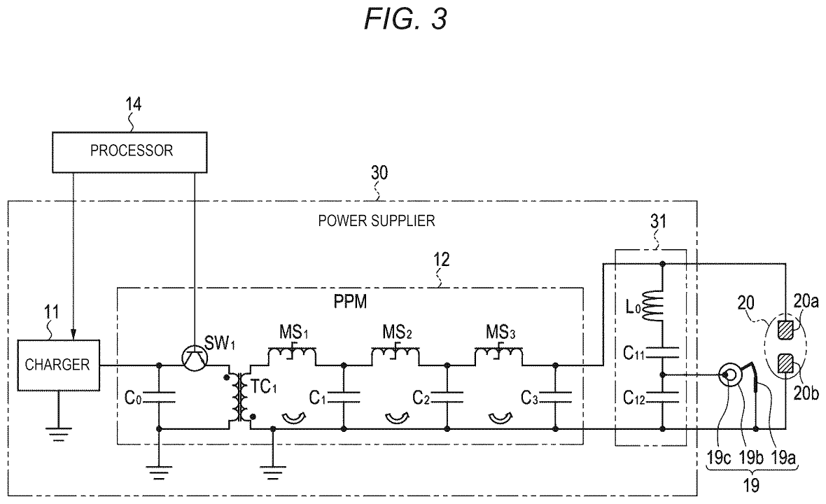

The charger 11 is a high voltage power supply that supplies the charging voltage Vhv to the charging capacitor C₀ incorporated in the PPM 12. The switch SW₁ in the PPM 12 is controlled by the processor 14. When the switch SW₁ is turned ON from OFF, the PPM 12 generates high voltage pulses from the electrical energy stored in the charging capacitor C₀ and applies the pulses to the primary electrode 20. As will be described later in detail with reference to FIG. 3, the charger 11 and the PPM 12 are provided in a power supplier 30, which supplies power to the preliminary ionization electrode 19 and the primary electrode 20.

The processor 14 is a processing apparatus that transmits and receives various signals to and from an exposure apparatus controller 110 provided in an exposure apparatus 100. For example, target pulse energy Et of the pulse laser light PL to be output to the exposure apparatus 100, an oscillation trigger signal, and other factors are transmitted from the exposure apparatus controller 110 to the processor 14.

The processor 14 harmoniously controls the operations of the elements of the gas laser apparatus 2 based on the various signals transmitted from the exposure apparatus controller 110, the measured value of the pulse energy, the detected value of the gas pressure, and other pieces of information.

The processor 14 functions as a controller of the gas laser apparatus 2. For example, the processor 14 is a processing device including a storage device that stores a control program and a CPU (central processing unit) that executes the control program. The processor 14 is particularly configured or programmed to carry out various processes described in the present disclosure. The storage device is a non-transitory computer-readable storage medium, and includes, for example, a memory that is a primary storage device and a storage that is an auxiliary storage device. Note that the storage devices may each be a semiconductor memory, a hard disk drive (HDD) device, a solid-state drive (SSD) device, or a combination of multiple of these devices.

### 1.1.2 Operation

The operation of the gas laser apparatus 2 according to Comparative Example will next be described. The processor 14 first controls the laser gas supplier 18a to cause it to supply the laser gas into the laser chamber 10, and drives the motor 23a to rotate the fan 23. The laser gas in the laser chamber 10 thus circulates.

The processor 14 receives the target pulse energy Et and the oscillation trigger signal transmitted from the exposure apparatus controller 110. Note that the oscillation trigger signal is a signal that instructs the gas laser apparatus 2 to output the pulse laser light PL corresponding to one pulse.

The processor 14 sets the charging voltage Vhv corresponding to the target pulse energy Et in the charger 11. The processor 14 operates the switch SW₁ in the PPM 12 in synchronization with the oscillation trigger signal.

When the switch SW₁ in the PPM 12 is turned ON from OFF, a voltage is applied to the space between the preliminary ionization inner electrode 19c and the preliminary ionization outer electrode 19a of the preliminary ionization electrode 19, and a voltage is applied to the space between the cathode electrode 20a and the anode electrode 20b. As a result, corona discharge occurs at the preliminary ionization electrode 19, so that UV (ultraviolet) light is generated. Irradiating the laser gas in the discharge space 27 with the UV light preliminarily ionizes the laser gas.

Thereafter, when the voltage between the cathode electrode 20a and the anode electrode 20b reaches the dielectric breakdown voltage, the primary discharge occurs in the discharge space 27. Assuming that the discharge direction of the primary discharge is the direction in which the electrons flow, the discharge direction is the direction from the cathode electrode 20a toward the anode electrode 20b. When the primary discharge occurs, the laser gas in the discharge space 27 is excited and emits light.

The metal dampers 29 prevent acoustic waves generated by the primary discharge from being reflected back to the discharge space 27 again. Furthermore, when the laser gas circulates in the laser chamber 10, discharge products generated in the discharge space 27 move downstream.

The light emitted from the laser gas is reflected off the line narrowing module 15 and the output coupler 16 and travels back and forth in the laser resonator, so that laser oscillation occurs. The light having a bandwidth narrowed by the line narrowing module 15 is output as the pulse laser light PL via the output coupler 16.

Part of the pulse laser light PL output via the output coupler 16 enters the pulse energy measuring unit 13. The pulse energy measuring unit 13 measures pulse energy E of the incident pulse laser light PL, and outputs the measured value to the processor 14.

The processor 14 calculates a difference ΔE between the measured pulse energy E and the target pulse energy Et. The processor 14 performs feedback control on the charging voltage Vhv in such a way that the measured pulse energy E becomes the target pulse energy Et based on the difference AE.

The processor 14 controls the laser gas supplier 18a to cause it to supply the laser gas into the laser chamber 10 until a predetermined pressure is reached when the charging voltage Vhv becomes higher than the maximum value of an allowable range. When the charging voltage Vhv becomes lower than the minimum value of the allowable range, the processor 14 controls the laser gas discharger 18b to cause it to discharge the laser gas from the interior of the laser chamber 10 until the predetermined pressure is reached.

Note that the gas laser apparatus 2 is not necessarily limited to a narrowed-line laser apparatus, and may instead be a laser apparatus that outputs spontaneously oscillating light. For example, the line narrowing module 15 may be replaced with a highly reflective mirror.

Furthermore, in FIGS. 1 and 2, an excimer laser apparatus is shown as the gas laser apparatus 2 by way of example, and the gas laser apparatus 2 may instead, for example, be an F₂ laser apparatus using a laser gas containing a fluorine gas and a buffer gas.

### 1.2 Power Supplier

### 1.2.1 Configuration

FIG. 3 schematically shows the configuration of the power supplier 30 according to Comparative Example. The power supplier 30 includes the charger 11, the PPM 12, and a voltage dividing circuit 31. The power supplier 30 causes the preliminary ionization electrode 19 and the primary electrode 20 to perform discharge by supplying power to the preliminary ionization electrode 19 and the primary electrode 20 under the control of the processor 14.

The voltage dividing circuit 31 and the primary electrode 20 are connected in parallel to each other to the output terminal of the PPM 12. The preliminary ionization electrode 19 is connected to the voltage dividing circuit 31.

The PPM 12 includes the switch SW₁ described above, a transformer TC₁, magnetic switches MS₁, MS₂, and MS₃, the charging capacitor C₀, and capacitors C₁, C₂, and C₃. The charging capacitor C₀ is connected to the charger 11. The charger 11 is a DC charger. The switch SW₁ is a semiconductor switching device, for example, an insulated gate bipolar transistor (IGBT). The switch SW₁ is turned ON and OFF based on a control signal from the processor 14. Note that the transformer TC₁ is an example of a “first transformer” according to the technology of the present disclosure.

The magnetic switches MS₁, MS₂, and MS₃ and the capacitors C₁ and C₂ constitute a magnetic pulse compression circuit that compresses the pulse width of a current flowing from the transformer TC₁ to the capacitor C₃. Note that the capacitor C₃ is an example of a “peaking capacitor” according to the technology of the present disclosure.

The switch SW₁ is provided between the charging capacitor C₀ and the primary side of the transformer TC₁. The magnetic switch MS₁ is provided between the secondary side of the transformer TC₁ and the capacitor C₁. The magnetic switch MS₂ is provided between the capacitor C₁ and the capacitor C₂. The magnetic switch MS₃ is provided between the capacitor C₂ and the capacitor C₃.

In the transformer TC₁, the primary side and the secondary side are electrically isolated from each other. In the transformer TC₁, the primary-side and secondary-side windings are wound in opposite directions, that is, the transformer TC₁ has additive polarity. Note that when the primary-side and secondary-side windings are wound in the same direction, the transformer has subtractive polarity.

The voltage dividing circuit 31 is configured with an inductance L₀, a capacitor C₁₁, and a capacitor C₁₂ connected to each other in series, and prevents dielectric breakdown caused by application of an excessive voltage to the preliminary ionization electrode 19. The preliminary ionization inner electrode 19c of the preliminary ionization electrode 19 is connected to a connecting point where the capacitor C₁₁ and the capacitor C₁₂ are connected to each other. The capacitor C₁₂ functions as a preliminary ionization capacitor used to apply a voltage to the preliminary ionization electrode 19.

### 1.2.2 Operation

The operation of the power supplier 30 will next be described. The processor 14 first sets the charging voltage Vhv in the charger 11. The charger 11 charges the charging capacitor C₀ based on the set charging voltage Vhv.

In the PPM 12, when a control signal is transmitted from the processor 14 to the switch SW₁, the switch SW₁ is closed, and a current flows from the charging capacitor C₀ to the primary side of the transformer TC₁.

In the transformer TC₁, the current flows to the primary side of the transformer TC₁, so that a current flows in the opposite direction on the secondary side of the transformer TC₁ through electromagnetic induction. An electromotive force generated by the current flowing on the secondary side of the transformer TC₁ closes the magnetic switch MS₁, and the current flows from the secondary side of the transformer TC₁ to the capacitor C₁, so that the capacitor C₁ is charged.

When the capacitor C₁ is charged, the magnetic switch MS₂ is closed, and a current flows from the capacitor C₁ to the capacitor C₂, so that the capacitor C₂ is charged. In this process, the capacitor C₂ is charged with the current having a pulse width shorter than the pulse width of the current used to charge the capacitor C₁.

When the capacitor C₂ is charged, the magnetic switch MS₃ is closed, and a current flows from the capacitor C₂ to the capacitor C₃, so that the capacitor C₃ is charged. In this process, the capacitor C₃ is charged with the current having a pulse width shorter than the pulse width of the current used to charge the capacitor C₂.

As described above, the current flows sequentially through the capacitor C₁, the capacitor C₂, and the capacitor C₃, so that the pulse width of the current is compressed, and charge is charged in the capacitor C₃.

A voltage is then applied from the capacitor C₃ to the voltage dividing circuit 31. The voltage dividing circuit 31 divides the applied voltage. When the divided voltage is applied from the capacitor C₁₂ to the preliminary ionization electrode 19, the corona discharge occurs. When the capacitor C₃ then applies a voltage to the primary electrode 20, the primary discharge occurs.

### 1.3 Problems

In the gas laser apparatus 2 according to Comparative Example, the primary discharge occurs at the primary electrode 20 in conjunction with the occurrence of the corona discharge at the preliminary ionization electrode 19, and the primary discharge excites the laser gas, so that the pulse laser light PL is generated.

The laser gas contains a carbon component derived from carbon adhering to the inner wall of the laser chamber 10, the O-ring, and the like. Fluorocarbon (CF₄) is generated when the primary discharge causes the carbon component contained in the laser gas to react with the fluorine. It is conceivable that the fluorocarbon is decomposed by the pulse laser light PL generated by the primary discharge or the primary discharge itself and therefore removed to some extent, but the amount of generated fluorocarbon is greater than the amount of removed fluorocarbon, so that the repeatedly performed primary discharge increases the concentration of the fluorocarbon in the laser gas. Since the fluorocarbon is characterized by absorbing the pulse laser light PL, repeatedly performed primary discharge reduces the pulse energy of the pulse laser light PL output from the gas laser apparatus 2.

### 2. First Embodiment

### 2.1 Configuration

A gas laser apparatus 2 according to a first embodiment of the present disclosure is configured in the same manner as the gas laser apparatus 2 according to Comparative Example except that the processor 14 carries out different processes. Furthermore, in the present embodiment, the power supplier 30 is configured in the same manner as in Comparative Example.

In the present embodiment, the processor 14 controls the charging voltage applied by the charger 11 to perform first discharge control that causes the preliminary ionization electrode 19 and the primary electrode 20 to perform discharge, and second discharge control that causes only the preliminary ionization electrode 19 to perform discharge. In the present embodiment, the processor 14 performs the first discharge control and the second discharge control by changing the charging voltage.

As the first discharge control, the processor 14 sets a first charging voltage Vhv1 in the charger 11, and turns ON the switch SW₁ after the charging capacitor C₀ is charged. The first charge voltage Vhv1 is a voltage corresponding to the target pulse energy Et, and is a voltage higher than or equal to a breakdown voltage at which breakdown occurs in the discharge space 27, as in Comparative Example. For example, the breakdown voltage is 10 kV. That is, the first charging voltage Vhv1 is higher than or equal to 10 kV. When the first charging voltage Vhv1 is set in the charger 11, the preliminary ionization electrode 19 and the primary electrode 20 perform discharge.

As the second discharge control, the processor 14 sets a second charging voltage Vhv2, which is lower than the first charging voltage Vhv1, in the charger 11 and turns ON the switch SW₁ after the charging capacitor C₀ is charged. The second charging voltage Vhv2 is a voltage lower than the breakdown voltage. For example, the second charging voltage Vhv2 is higher than or equal to 4 kV but lower than or equal to 9 kV. When the second charging voltage Vhv2 is set in the charger 11, only the preliminary ionization electrode 19 performs discharge.

### 2.2 Operation

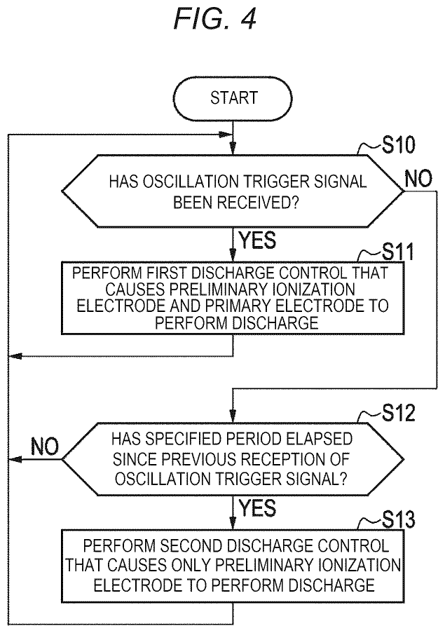

The operation of the gas laser apparatus 2 according to the first embodiment will next be described. FIG. 4 shows the procedure of processes carried out by the processor 14 according to the first embodiment.

First, in step S10, the processor 14 determines whether it has received the oscillation trigger signal transmitted from the exposure apparatus controller 110. When the processor 14 determines that it has received the oscillation trigger signal (YES in step S10), the processor 14 transitions to the process in step S11.

In step S11, the processor 14 sets the first charging voltage Vhv1 in the charger 11, and turns ON the switch SW₁ after the charging capacitor C₀ is charged to cause the preliminary ionization electrode 19 and the primary electrode 20 to perform discharge. The corona discharge and primary discharge thus occur.

After step S11, the processor 14 returns to the process in step S10. The processor 14 repeatedly executes steps S10 and S11 until the result of step S10 is NO.

When the processor 14 determines that it has not received the oscillation trigger signal (NO in step S10), the processor 14 transitions to the process in step S12.

In step S12, the processor 14 determines whether a specified period has elapsed since the previous reception of the oscillation trigger signal (step S12). When the processor 14 determines that the specified period has elapsed since the previous reception of the oscillation trigger signal (YES in step S12), the processor 14 transitions to the process in step S13.

In step S13, the processor 14 sets the second charging voltage Vhv2 in the charger 11, and turns ON the switch SW₁ after the charging capacitor C₀ is charged to cause only the preliminary ionization electrode 19 to perform discharge (step S13). Only the corona discharge thus occurs.

When the processor 14 determines that the specified period has not elapsed since the previous reception of the oscillation trigger signal (NO in step S12), the process reruns to the process in step S10.

The processor 14 thus performs the first discharge control, which causes the primary electrode 20 and the preliminary ionization electrode 19 to perform discharge based on an instruction from the exposure apparatus 100, and then performs the second discharge control, which causes only the preliminary ionization electrode 19 to perform discharge when the specified period has elapsed. That is, the processor 14 does not cause the primary discharge to occur but causes only the corona discharge to occur during the period for which the pulse laser light PL is not output.

When the exposure apparatus 100 is inactive for maintenance or the like, the exposure apparatus 100 does not transmit the oscillation trigger signal to the gas laser apparatus 2, and the processor 14 carries out the processes described above to cause only the preliminary ionization electrode 19 to perform discharge.

When the gas laser apparatus 2 repeatedly performs burst oscillation and stops the burst oscillation, the preliminary ionization electrode 19 and the primary electrode 20 perform discharge during the burst oscillation period, and only the preliminary ionization electrode 19 performs discharge during the burst oscillation suspension period. The burst oscillation is an operation in which the gas laser apparatus 2 outputs the pulse laser light PL at a constant frequency in response to the oscillation trigger signal transmitted from the exposure apparatus 100 at the constant frequency. The burst oscillation suspension period is a period for which the gas laser apparatus 2 stops the burst oscillation, and is an interval period between two burst oscillation periods. During the burst oscillation period, the exposure apparatus 100 irradiates a wafer via a reticle with the pulse laser light PL supplied from the gas laser apparatus 2 at the constant frequency. In the burst oscillation suspension period, the wafer and the reticle are replaced with others in the exposure apparatus 100.

### 2.3 Advantages

In the present embodiment, the primary discharge repeatedly performed increases the concentration of the fluorocarbon in the laser gas, but only the corona discharge occurs, and the UV light is generated during the period for which the pulse laser light PL is not output. During this period, the fluorocarbon in the laser gas is decomposed by the UV light and the corona discharge, so that the concentration of the fluorocarbon in the laser gas decreases. The present embodiment can therefore lower the concentration of the fluorocarbon in the laser gas to suppress a decrease in the pulse energy of the pulse laser light PL output from the gas laser apparatus 2.

### 3. Second Embodiment

### 3.1 Configuration

A gas laser apparatus 2 according to a second embodiment of the present disclosure is configured in the same manner as the gas laser apparatus 2 according to the first embodiment except that the processor 14 carries out different processes and the power supplier 30 has a different configuration.

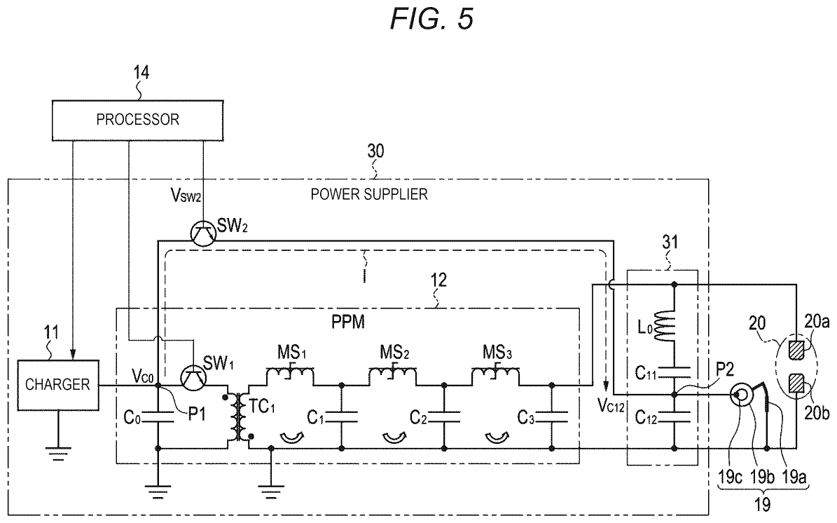

FIG. 5 schematically shows the configuration of a power supplier 30 according to the second embodiment. In the present embodiment, the power supplier 30 includes a switch SW₂ in addition to the charger 11, the PPM 12, and the voltage dividing circuit 31.

The switch SW₂ is connected to and disposed between the charging capacitor C₀ and the voltage dividing circuit 31. Specifically, the switch SW₂ is connected to and disposed between a connection point P1, where the charger 11 is connected to the charging capacitor C₀, and a connection point P2, where the capacitor Cui is connected to the capacitor C₁₂. Note that the switch SW₂ is an example of a “second switch” according to the technology of the present disclosure.

The switch SW₂ is, for example, a semiconductor switching device such as an IGBT. The switch SW₂ is turned ON and OFF based on a control signal from the processor 14. The processor 14 causes a current I to flow or not flow from the charging capacitor C₀ to the capacitor C₁₂ via the switch SW₂.

In the present embodiment, the processor 14 controls the switches SW₁ and SW₂ to perform the first discharge control, which causes the preliminary ionization electrode 19 and the primary electrode 20 to perform discharge, and the second discharge control, which causes only the preliminary ionization electrode 19 to perform discharge. In the present embodiment, the charging voltage Vhv set in the charger 11 is a value corresponding to the target pulse energy Et.

In the present embodiment, as the first discharge control, the processor 14 sets the charging voltage Vhv in the charger 11, and turns ON the switch SW₁ with the switch SW₂ remaining turned OFF after the charging capacitor C₀ is charged. The charging voltage Vhv is a voltage higher than or equal to the breakdown voltage. The preliminary ionization electrode 19 and the primary electrode 20 thus perform discharge.

In the present embodiment, as the second discharge control, the processor 14 sets the charging voltage Vhv in the charger 11, and turns ON the switch SW₂ with the switch SW₁ remaining turned OFF after the charging capacitor C₀ is charged. In the second discharge control, the switch SW₂ is turned ON, so that the charging capacitor C₀ and the capacitor C₁₂ are electrically continuous with each other, and the current I therefore flows from the charging capacitor C₀ to the capacitor C₁₂. As a result, a voltage applied from the capacitor C₁₂ to the preliminary ionization electrode 19 causes only the preliminary ionization electrode 19 to perform discharge.

### 3.2 Operation

The operation of the gas laser apparatus 2 according to the second embodiment will next be described. In the present embodiment, the procedure of processes carried out by the processor 14 is the same as the procedure of the processes shown in FIG. 4.

In the present embodiment, in step S11, the processor 14 sets the charging voltage Vhv in the charger 11, and turns ON the switch SW₁ with the switch SW₂ remaining turned OFF after the charging capacitor C₀ is charged to cause the preliminary ionization electrode 19 and the primary electrode 20 to perform discharge. The primary discharge thus occurs in conjunction with the corona discharge.

In step S13, the processor 14 sets the charging voltage Vhv in the charger 11, and turns ON the switch SW₂ with the switch SW₁ remaining turned OFF after the charging capacitor C₀ is charged to cause only the preliminary ionization electrode 19 to perform discharge. Only the corona discharge thus occurs.

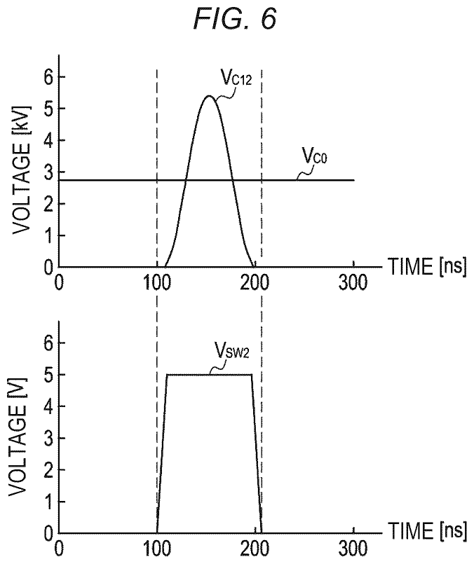

FIG. 6 shows a result of a simulation of the various voltages applied to the power supplier 30 according to the second embodiment. V_{C0} represents the voltage across the charging capacitor C₀. V_{C12} represents the voltage across the capacitor C₁₂. V_{SW2} represents a voltage carried by a control signal and applied from the processor 14 to the switch SW₂.

It is assumed in the present simulation that the capacitance of the charging capacitor C₀ is sufficiently greater than the capacitance of the capacitor C₁₂. In this case, V_{C12} varies within a range smaller than or equal to twice the voltage V_{C0}, as shown in FIG. 6.

### 3.3 Advantages

According to the present embodiment, since only the corona discharge is caused to occur during the period for which the pulse laser light PL is not output to lower the concentration of the fluorocarbon in the laser gas, so that the decrease in the pulse energy of the pulse laser light PL can be suppressed, as in the first embodiment.

### 4. Third Embodiment

### 4.1 Configuration

A gas laser apparatus 2 according to a third embodiment of the present disclosure is configured in the same manner as the gas laser apparatus 2 according to the second embodiment except that the power supplier 30 has a different configuration.

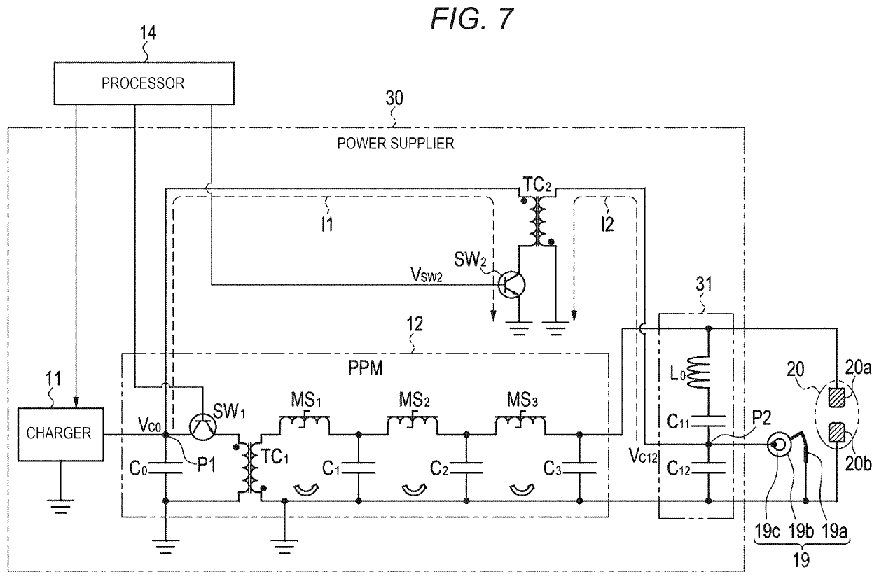

FIG. 7 schematically shows the configuration of a power supplier 30 according to the third embodiment. In the present embodiment, the power supplier 30 includes a transformer TC₂ and the switch SW₂ in addition to the charger 11, the PPM 12, and the voltage dividing circuit 31.

The transformer TC₂ is connected to and disposed between the charging capacitor C₀ and the voltage dividing circuit 31. Specifically, in the transformer TC₂, the primary side is connected to the connection point P1 described above, and the secondary side is connected to the connection point P2 described above. In the present embodiment, the transformer TC₂ has additive polarity. Note that the transformer TC₂ is an example of a “second transformer” according to the technology of the present disclosure.

In the present embodiment, the switch SW₂ is connected to the primary side of the transformer TC₂. The switch SW₂ is, for example, a semiconductor switching device such as an IGBT. The switch SW₂ is turned ON and OFF based on a control signal from the processor 14. The processor 14 causes a current I1 to flow or not flow from the charging capacitor C₀ to the primary side of the transformer TC₂ via the switch SW₂. Note that the switch SW₂ is an example of a “second switch” according to the technology of the present disclosure.

In the present embodiment, in which the transformer TC₂ has additive polarity, the current I1 flows to the primary side of the transformer TC₂, so that a current I2 flows in the opposite direction on the secondary side of the transformer TC₂. Note that the transformer TC₂ may have subtractive polarity.

In the present embodiment, the processor 14 controls the switches SW₁ and SW₂ to perform the first discharge control, which causes the preliminary ionization electrode 19 and the primary electrode 20 to perform discharge, and the second discharge control, which causes only the preliminary ionization electrode 19 to perform discharge, as in the second embodiment. In the present embodiment, the charging voltage Vhv set in the charger 11 is a value corresponding to the target pulse energy Et.

### 4.2 Operation

The operation of the gas laser apparatus 2 according to the third embodiment will next be described. In the present embodiment, the procedure of processes carried out by the processor 14 is the same as that in the second embodiment.

In the present embodiment, in step S13, the processor 14 turns ON the switch SW₂ with the switch SW₁ remaining turned OFF, so that the current I2 flows to the secondary side of the transformer TC₂ in response to the current I1 flowing to the primary side thereof. As a result, when a voltage is applied from the capacitor C₁₂ to the preliminary ionization electrode 19, discharge only occurs at the preliminary ionization electrode 19, so that only the corona discharge occurs. Other operations of the gas laser apparatus 2 according to the present embodiment are the same as those in the second embodiment.

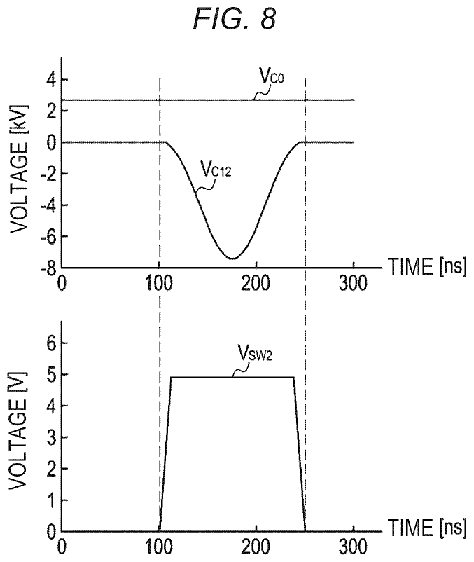

FIG. 8 shows a result of a simulation of the various voltages applied to the power supplier 30 according to the third embodiment. V_{C0} represents the voltage across the charging capacitor C₀. V_{C12} represents the voltage across the capacitor C₁₂. V_{SW2} represents a voltage carried by a control signal and applied from the processor 14 to the switch SW₂.

It is assumed in the present simulation that the capacitance of the charging capacitor C₀ is sufficiently greater than the capacitance of the capacitor C₁₂. In this case, the absolute value of V_{C12} varies within a range smaller than or equal to the voltage V_{C0} times 2×N₁/N₂. In the present simulation, N₁/N₂ is set to two. In the present simulation, the polarity of V_{C12} is reversed because the transformer TC₂ has additive polarity.

### 4.3 Advantages

According to the present embodiment, since only the corona discharge is caused to occur during the period for which the pulse laser light PL is not output to lower the concentration of the fluorocarbon in the laser gas, so that the decrease in the pulse energy of the pulse laser light PL can be suppressed, as in the first embodiment.

### 5. Fourth Embodiment

### 5.1 Configuration

A gas laser apparatus 2 according to a fourth embodiment of the present disclosure is configured in the same manner as the gas laser apparatus 2 according to the second embodiment except that the processor 14 carries out different processes and the power supplier 30 has a different configuration.

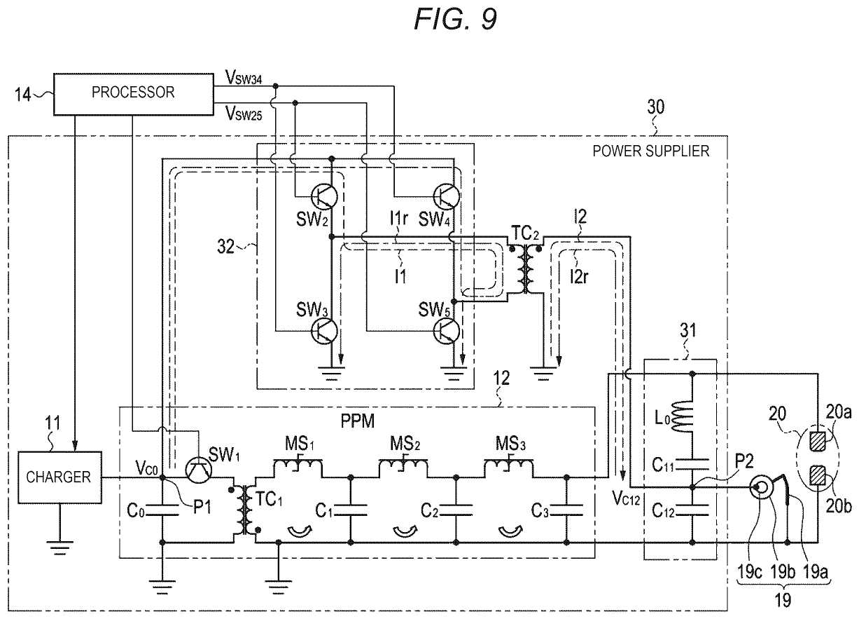

FIG. 9 schematically shows the configuration of a power supplier 30 according to the fourth embodiment. In the present embodiment, the power supplier 30 includes the transformer TC₂ and a full-bridge circuit 32 in addition to the charger 11, the PPM 12, and the voltage dividing circuit 31.

The transformer TC₂ is provided between the charging capacitor C₀ and the voltage dividing circuit 31. The full-bridge circuit 32 is connected to and disposed between the charging capacitor C₀ and the primary side of the transformer TC₂. Specifically, in the transformer TC₂, the primary side is connected to the connection point P1 described above via the full-bridge circuit 32, and the secondary side is connected to the connection point P2 described above. In the present embodiment, the transformer TC₂ has subtractive polarity. Note that the transformer TC₂ is an example of a “second transformer” according to the technology of the present disclosure.

The full-bridge circuit 32 is configured with switches SW₂, SW₃, SW₄, and SW₅, and can cause a current to flow or not to flow to the primary side of the transformer TC₂ and control the direction of the current. The switches SW₂, SW₃, SW₄, and SW₅ are each, for example, a semiconductor switching device such as an IGBT.

The switches SW₂ and SW₃ are connected in series to and disposed between the connection point P1 and the ground. The switches SW₄ and SWs are connected in series to and disposed between the connection point P1 and the ground. An end of the primary side of the transformer TC₂ is connected to and disposed between the switch SW₂ and the switch SW₃. The other end of the primary side of the transformer TC₂ is connected to and disposed between the switch SW₄ and the switch SW₅. The switches SW₂ and SWs are turned ON and OFF based on a first control signal from the processor 14. The switches SW₃ and SW₄ are turned ON and OFF based on a second control signal from the processor 14.

The processor 14 causes a current to flow or not to flow from the charging capacitor C₀ to the primary side of the transformer TC₂ via the full-bridge circuit 32 and controls the direction of the current. Specifically, the processor 14 alternately turns ON the switches SW₂ and SW₅ or the switch SW₃ and SW₄. The current I1 in the positive direction or a current I1r in the opposite direction alternately flows to the primary side of the transformer TC₂. As a result, the current I2 in the positive direction or a current I2r in the opposite direction alternately flows to the secondary side of the transformer TC₂, so that a positive voltage or a negative voltage is alternately applied to the preliminary ionization electrode 19.

In the present embodiment, in which the transformer TC₂ has subtractive polarity, the current I1 flowing to the primary side of the transformer TC₂ causes the current I2 to flow in the same direction on the secondary side of the transformer TC₂. The current I1r flowing to the primary side of the transformer TC₂ further causes the current I2r to flow in the same direction on the secondary side of the transformer TC₂. Note that the transformer TC₂ may have additive polarity.

In the present embodiment, the processor 14 controls the switch SW₁ and the full-bridge circuit 32 to perform the first discharge control, which causes the preliminary ionization electrode 19 and the primary electrode 20 to perform discharge, and the second discharge control, which causes only the preliminary ionization electrode 19 to perform discharge, as in the second embodiment. In the present embodiment, the charging voltage Vhv set in the charger 11 is a value corresponding to the target pulse energy Et.

### 5.2 Operation

The operation of the gas laser apparatus 2 according to the fourth embodiment will next be described. In the present embodiment, the procedure of processes carried out by the processor 14 is the same as the procedure of the processes shown in FIG. 4.

In the present embodiment, in step S11, the processor 14 sets the charging voltage Vhv in the charger 11, and turns ON the switch SW₁ with the switches SW₂, SW₃, SW₄, and SW₅ of the full-bridge circuit 32 all remaining turned OFF after the charging capacitor C₀ is charged. The preliminary ionization electrode 19 and the primary electrode 20 thus perform discharge.

In step S13, the processor 14 sets the charging voltage Vhv in the charger 11, and turns ON one of the set of the switches SW₂ and SW₅ and the set of the switches SW₃ and SW₄ with the switch SW₁ remaining turned OFF after the charging capacitor C₀ is charged. Only the preliminary ionization electrode 19 thus performs discharge.

Whenever the processor 14 executes step S13, the processor 14 turns ON the set of switches different from the set of switches last turned ON out of the set of the switches SW₂ and SW₅ and the set of the switches SW₃ and SW₄. That is, the processor 14 alternately turns ON the switches SW₂ and SW₅ or the switches SW₃ and SW₄. Corona discharge having positive polarity or corona discharge having negative polarity thus alternately occurs.

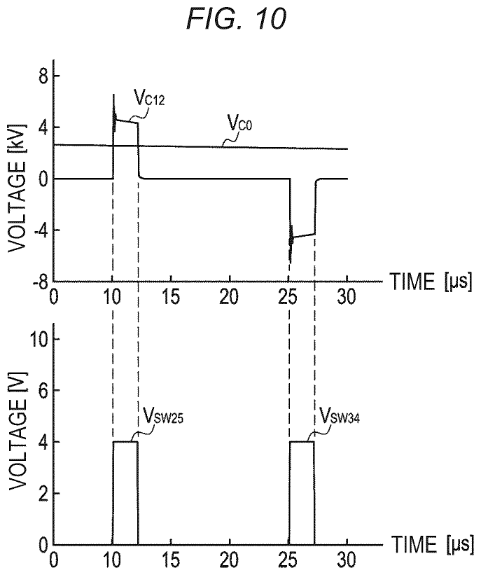

FIG. 10 shows a result of a simulation of the various voltages applied to the power supplier 30 according to the fourth embodiment. V_{C0} represents the voltage across the charging capacitor C₀. V_{C12} represents the voltage across the capacitor C₁₂. V_{SW25} represents a voltage of the first control signal applied from the processor 14 to the switches SW₂ and SW₅. V_{SW34} represents a voltage of the second control signal applied from the processor 14 to the switches SW₃ and SW₄.

It is assumed in the present simulation that the capacitance of the charging capacitor C₀ is sufficiently greater than the capacitance of the capacitor C₁₂. In this case, the absolute value of V_{C12} varies within a range smaller than or equal to the voltage V_{C0} times 2×N₁/N₂.

### 5.3 Advantages

According to the present embodiment, since only the corona discharge is caused to occur during the period for which the pulse laser light PL is not output to lower the concentration of the fluorocarbon in the laser gas, so that the decrease in the pulse energy of the pulse laser light PL can be suppressed, as in the first embodiment.

### 6. Fifth Embodiment

### 6.1 Configuration

A gas laser apparatus 2 according to a fifth embodiment of the present disclosure is configured in the same manner as the gas laser apparatus 2 according to the first embodiment except that the processor 14 carries out different processes and the power supplier 30 has a different configuration.

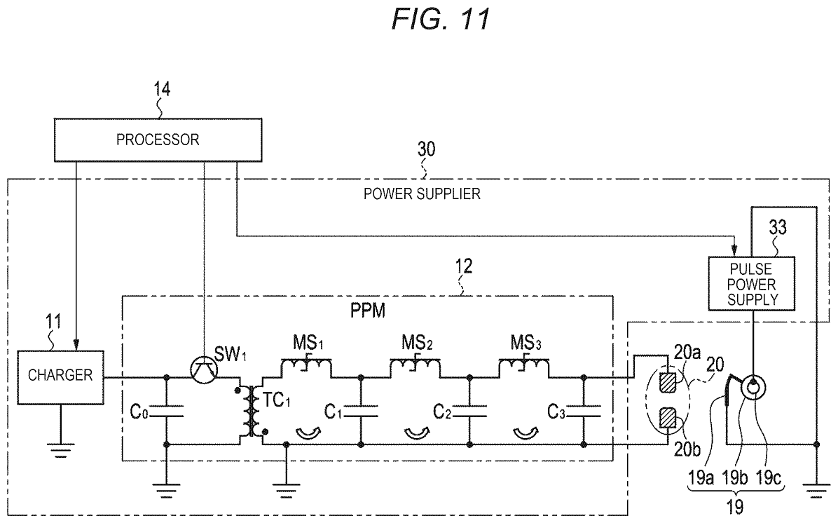

FIG. 11 schematically shows the configuration of a power supplier 30 according to the fifth embodiment. In the present embodiment, the power supplier 30 includes the charger 11, the PPM 12, and a pulse power supply 33. In the present embodiment, the voltage dividing circuit 31 is not provided, and the preliminary ionization electrode 19 is separate from the charger 11 and the PPM 12. Note that the pulse power supply 33 is an example of a “second power supply” according to the technology of the present disclosure. In the present embodiment, the PPM 12 supplies power to the primary electrode 20, and the pulse power supply 33 supplies power to the preliminary ionization electrode 19.

The pulse power supply 33 is connected to the preliminary ionization electrode 19. Specifically, the pulse power supply 33 is connected to and disposed between the preliminary ionization outer electrode 19a and the preliminary ionization inner electrode 19c. The pulse power supply 33 is connected to the processor 14, and applies a pulse voltage to the preliminary ionization electrode 19 based on a control signal from the processor 14. For example, the pulse voltage is higher than or equal to 3 kV but lower than or equal to 8 kV.

In the present embodiment, the processor 14 controls the charger 11 and the pulse power supply 33 to perform the first discharge control, which causes the preliminary ionization electrode 19 and the primary electrode 20 to perform discharge, and the second discharge control, which causes only the preliminary ionization electrode 19 to perform discharge.

### 6.2 Operation

The operation of the gas laser apparatus 2 according to the fifth embodiment will next be described. In the present embodiment, the procedure of processes carried out by the processor 14 is the same as the procedure of the processes shown in FIG. 4.

In the present embodiment, in step S11, the processor 14 sets the charging voltage Vhv in the charger 11, and controls the pulse power supply 33 to apply the pulse voltage to the preliminary ionization electrode 19 with the switch SW₁ remaining turned OFF to cause the preliminary ionization electrode 19 to perform discharge. After the charging capacitor C₀ is charged, the switch SW₁ is turned ON to cause the primary electrode 20 to perform discharge.

In step S13, the processor 14 controls the pulse power supply 33 to apply the pulse voltage to the preliminary ionization electrode 19 with the switch SW₁ remaining turned OFF to cause only the preliminary ionization electrode 19 to perform discharge.

### 6.3 Advantages

According to the present embodiment, since only the corona discharge is caused to occur during the period for which the pulse laser light PL is not output to lower the concentration of the fluorocarbon in the laser gas, so that the decrease in the pulse energy of the pulse laser light PL can be suppressed, as in the first embodiment.

Furthermore, according to the present embodiment, since the pulse power supply 33, which is an element separate from the charger 11, is used, the pulse voltage can be directly applied to the preliminary ionization electrode 19 without using capacitors for preliminary ionization. The efficiency of the corona discharge is thus improved.

### 7. Variations

In each of the embodiments described above, the processor 14 performs the first discharge control and then performs the second discharge control when the specified period has elapsed based on the oscillation trigger signal transmitted from the exposure apparatus 100, as shown in FIG. 4. Instead, the processor 14 may perform the second discharge control when the processor 14 receives a signal indicating that the exposure apparatus 100 is inactive from the exposure apparatus 100. Still instead, the processor 14 may perform the second discharge control when the processor 14 receives a signal indicating that the exposure apparatus 100 is in the burst oscillation suspension period from the exposure apparatus 100.

In each of the embodiments described above, the processor 14 repeatedly performs the second discharge control as long as the processor 14 does not receive the oscillation trigger signal from the exposure apparatus 100 after the specified period has elapsed as shown in FIG. 4, and the number of times the second discharge control is performed may instead be restricted. Specifically, when the second discharge control is performed, the number of times the second discharge control is performed may be restricted in accordance with the number of times the first discharge control has been performed immediately before the second discharge control. For example, the number of times the second discharge control is performed may be restricted to numbers greater than or equal to 0.001% of the number of times the first discharge control is performed immediately before the second discharge control but smaller than or equal to 1% thereof. For example, after the primary discharge is performed one hundred thousand times, only the corona discharge is performed one to thousand times.

### 8. Electronic Device Manufacturing Method

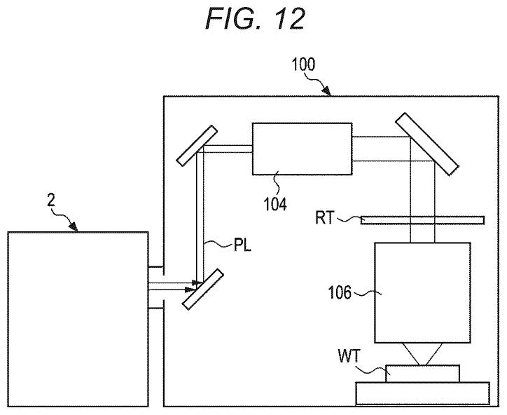

FIG. 12 schematically shows an example of the configuration of the exposure apparatus 100. The exposure apparatus 100 includes an illumination optical system 104 and a projection optical system 106. The illumination optical system 104 illuminates a reticle pattern of a reticle that is not shown but is placed on a reticle stage RT, for example, with the pulse laser light PL having entered the illumination optical system 104 from the gas laser apparatus 2. The projection optical system 106 performs reduction projection on the pulse laser light PL having passed through the reticle to bring the pulse laser light PL into focus at a workpiece that is not shown but is placed on a workpiece table WT. The workpiece is a photosensitive substrate onto which a photoresist has been applied, such as a semiconductor wafer.

The exposure apparatus 100 synchronously translates the reticle stage RT and the workpiece table WT to expose the workpiece to the pulse laser light PL having reflected the reticle pattern. Semiconductor devices can be manufactured by transferring the reticle pattern onto the semiconductor wafer in the exposure step described above and then carrying out multiple other steps. The semiconductor devices are an example of the “electronic devices” in the present disclosure.

Note that the gas laser apparatus 2 does not necessarily manufacture electronic devices, and can also be used to perform laser processing such as drilling.

The above description is intended not to be limiting but merely to be illustrative. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, the term “include” or “included” should be interpreted as “is not limited to what is described as included”. The term “have” should be interpreted as “is not limited to what is described as having”. Furthermore, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A gas laser apparatus comprising:
a laser chamber configured to encapsulate a laser gas containing a fluorine gas;
a primary electrode disposed in the laser chamber;
a preliminary ionization electrode disposed in the laser chamber;
a power supplier configured to supply power to the primary electrode and the preliminary ionization electrode; and
a processor configured to control the power supplier to perform first discharge control that causes the preliminary ionization electrode and the primary electrode to perform discharge, and second discharge control that causes only the preliminary ionization electrode to perform discharge without causing the primary electrode to perform discharge.

2. The gas laser apparatus according to claim 1, wherein
the processor is configured to perform the first discharge control based on an instruction from an exposure apparatus, and then perform the second discharge control when a specified period elapses.

3. The gas laser apparatus according to claim 1, wherein
the processor is configured to perform the second discharge control when an exposure apparatus is inactive.

4. The gas laser apparatus according to claim 1, wherein
the processor is configured to perform the second discharge control during a burst oscillation suspension period.

5. The gas laser apparatus according to claim 1, wherein
the power supplier includes a first power supply and a power generation circuit including a charging capacitor charged by the first power supply, and
the power generation circuit is configured to supply power to the primary electrode and the preliminary ionization electrode.

6. The gas laser apparatus according to claim 5, wherein
the processor is configured to perform the first discharge control and the second discharge control by changing a charging voltage applied to the charging capacitor.

7. The gas laser apparatus according to claim 6, wherein
the processor is configured to set a first charging voltage in the first power supply when performing the first discharge control, and set a second charging voltage lower than the first charging voltage in the first power supply when performing the second discharge control.

8. The gas laser apparatus according to claim 7, wherein
the first charging voltage is higher than or equal to 10 kV, and
the second charging voltage is higher than or equal to 4 kV but lower than or equal to 9 kV.

9. The gas laser apparatus according to claim 5, wherein
the power generation circuit includes a first transformer, a first switch provided between a primary side of the first transformer and the charging capacitor, a magnetic pulse compression circuit provided on a secondary side of the first transformer, and a peaking capacitor connected to the magnetic pulse compression circuit,
the primary electrode is connected in parallel to the peaking capacitor, and
the preliminary ionization electrode is connected to the peaking capacitor via a voltage dividing circuit.

10. The gas laser apparatus according to claim 9, wherein
the power supplier further includes a second switch connected to and disposed between the charging capacitor and the voltage dividing circuit, and
the processor is configured to perform the first discharge control and the second discharge control by controlling the first switch and the second switch.

11. The gas laser apparatus according to claim 9, wherein
the power supplier further includes a second transformer connected to and disposed between the charging capacitor and the voltage dividing circuit, and a second switch connected to a primary side of the second transformer, and
the processor is configured to perform the first discharge control and the second discharge control by controlling the first switch and the second switch.

12. The gas laser apparatus according to claim 9, wherein
the power supplier further includes a second transformer provided between the charging capacitor and the voltage dividing circuit, and a full-bridge circuit connected to and disposed between the charging capacitor and the primary side of the second transformer, and
the processor is configured to perform the first discharge control and the second discharge control by controlling the first switch and the full-bridge circuit.

13. The gas laser apparatus according to claim 1, wherein
the power supplier includes a first power supply, a power generation circuit including a charging capacitor charged by the first power supply, and a second power supply,
the power generation circuit is configured to supply power to the primary electrode, and
the second power supply is configured to supply power to the preliminary ionization electrode.

14. The gas laser apparatus according to claim 13, wherein
the second power supply is configured to apply a pulse voltage to the preliminary ionization electrode.

15. The gas laser apparatus according to claim 1, wherein
the number of times the processor performs the second discharge control is greater than or equal to 0.001% of the number of times the processor performs the first discharge control but smaller than or equal to 1% thereof.

16. An electronic device manufacturing method comprising:
generating laser light by using a gas laser apparatus;
outputting the laser light to an exposure apparatus; and
exposing a photosensitive substrate to the laser light in the exposure apparatus to manufacture electronic devices,
the gas laser apparatus including
a laser chamber configured to encapsulate a laser gas containing a fluorine gas,
a primary electrode disposed in the laser chamber,
a preliminary ionization electrode disposed in the laser chamber,
a power supplier configured to supply power to the primary electrode and the preliminary ionization electrode, and
a processor configured to control the power supplier to perform first discharge control that causes the preliminary ionization electrode and the primary electrode to perform discharge, and second discharge control that causes only the preliminary ionization electrode to perform discharge without causing the primary electrode to perform discharge.
